(19) United States
(12) Patent Application Publication
(10) Pub. No.: US 2023/0040687 A1
(43) Pub. Date: Feb. 9, 2023

(54) Method for Providing Brand Information and Apparatus for the Same

(71) Applicant: Coupang Corp., Seoul (KR)

(72) Inventors: Min Ji Kim, Seoul (KR); Jun Young Mun, Seoul (KR); Lei Wang, Seoul (KR); Jing Lu, Seoul (KR)

(73) Assignee: Coupang Corp., Seoul (KR)

(21) Appl. No.: 17/562,646

(22) Filed: Dec. 27, 2021

(30) Foreign Application Priority Data
Aug. 9, 2021 (KR) 10-2021-0104508

(51) Int. Cl. G06Q 30/06; G06Q 30/02; G06F 16/9536

(52) U.S. Cl. CPC G06Q 30/0643; G06Q 30/0627; G06Q 30/0204; G06F 16/9536

(57) ABSTRACT

A method for providing brand information according to example embodiments may include receiving the search term from a user of a service, when the search term is associated with a first brand, identifying a list of related brands associated with the first brand, providing a first page including a first area displaying a first item list corresponding to the search term and a second area displaying the list of related brands associated with the first brand, and in response to an input for a second brand included in the list of related brands, providing a second page including a third area displaying a second item list of the second brand.

[Technical Field]

The present disclosure relates to a method and apparatus for providing brand information, and more particularly, to a method and apparatus for identifying brand information and/or item information from a search term entered by a user, and providing the user with information on other brands associated with the brand information for the corresponding item.

[Description of the Related Art]

Recently, with the development of information and communication technology, Internet technology, and online payment technology, the scale of the online transaction and online shopping industry is actively expanding. Consumers' use of online shopping is increasing due to the advantages of online shopping that it is possible to easily shop anytime, anywhere and compare numerous items, and accordingly, the demand and interest in starting an online shopping mall is increasing. Meanwhile, the brand is one of the important factors in which consumers choose an item, and consumers decide whether to purchase the item by the brand.

In this regard, as a prior patent document, there is Korean Patent Registration Publication No. 10-2259567 (2021.06.01).

[Disclosure of the Invention]

[Technical Goals]

An aspect of the present disclosure is to provide a method and an apparatus for providing related brand information of an item.

More specifically, according to example embodiments of the present specification, the method for providing brand information may identify brand information and/or item information from a search term entered by a user, and may provide the user with information on other brands related to the brand information for the corresponding item.

[Technical Solutions]

According to an aspect, there is provided a method for providing brand information including receiving the search term from a user of a service, when the search term is associated with a first brand, identifying a list of related brands associated with the first brand, providing a first page including a first area displaying a first item list corresponding to the search term and a second area displaying the list of related brands associated with the first brand, and providing, according to an input for a second brand included in the list of related brands, a second page including a third area displaying a second item list of the second brand.

Further, the list of related brands according to example embodiments may be generated based on a search frequency of brands searched by other users who searched for the first brand.

In addition, the list of related brands according to example embodiments may be updated every specific period.

In addition, the list of related brands according to example embodiments may be generated based on checking times at which each user searched for the first brand within a first time period, setting at least one second time period for identifying brands searched by the user based on the times at which the first brand was searched for, and checking the search frequency of the brands searched by the user within the at least one second time period.

Furthermore, the first time period according to example embodiments may indicate a time period from a specific time before the current time to the current time, and the at least one second time period may be included in the first time period.

In addition, the list of related brands according to example embodiments may be generated differently for each age and gender of the users who searched for the first brand.

Furthermore, when an item corresponding to the search term according to example embodiments is not identified, the first area may include items related to brands other than the first brand, which are included in the list of related brand.

Furthermore, the second area according to example embodiments may display the brands other than the first brand included in the list of related brands in an order determined according to priority, and the priority may be determined based on a sales volume for the other brands.

Further, the second area according to example embodiments may include a first interface for requesting to search for items for the second brand which is different from the first brand and included in the list of related brand, and the method for providing brand information may further include displaying items for the second brand in the first area in response to the request.

Further, the second area according to example embodiments may or may not be displayed on the first page by a second interface included in the first page.

[Effects]

The electronic apparatus according to example embodiments may help a user to search for a preferred brand without an additional user input procedure by managing and updating a list of brands related to the brand searched by the user and presenting them.

The electronic apparatus according to example embodiments may grasp rapidly changing user needs, trends, and preferences by managing brands related with the brand searched by the user, and may provide a quick search function according to the user's needs and trends.

The electronic apparatus according to example embodiments may accurately predict the needs and demand changes of users who want to purchase by setting the first period and the second period to determine the search amount of users for each brand, and efficiently manage and identify the relationship between brands.

The electronic apparatus according to example embodiments may promote purchases of other brands from users by determining and presenting priorities of items provided to service users.

### [BRIEF DESCRIPTION OF THE DRAWINGS]

FIG. 1 illustrates an example of internal components of an electronic apparatus according to example embodiments.

FIG. 2 illustrates an example of a search result page providing information on brand information and items according to example embodiments.

FIG. 3 illustrates an example of a search result page that provides brand information, information on an item, and a function for filtering items according to example embodiments.

FIG. 4 illustrates an example of a method for generating and updating a related brand list according to example embodiments.

FIG. 5 shows an example of an item detail page according to example embodiments.

FIG. 6 illustrates an example of a method of generating, updating, and prioritizing a related brand list according to example embodiments.

FIG. 7 is a flowchart illustrating a method of providing brand information according to example embodiments.

[Detailed Description for Carrying Out the Invention]

Hereinafter, example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non- transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially in parallel, or may be performed in reverse order according to their functions.

According to various example embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

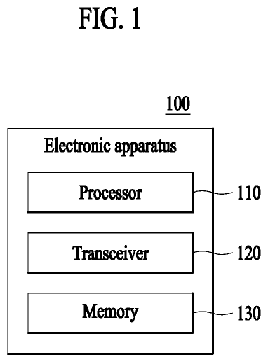

FIG. 1 illustrates an example of internal components of an electronic apparatus according to example embodiments.

Referring to FIG. 1, internal components of an electronic apparatus 100 are not limited to those illustrated. The electronic apparatus 100 may include at least one of a processor 110, a transceiver 120, and a memory 130.

The processor 110 may process a series of operations for performing a method for providing brand information according to various example embodiments of the present disclosure. The processor 110 may control other components of the electronic apparatus 100. Meanwhile, in an example embodiment, a product may be used as a term referring to a specific item, and the item may be sold to a user in a service related to the electronic apparatus 100.

The processor 110 may perform receiving a search term from a user of a service, when the search term is associated with a first brand, identifying a list of related brands associated with the first brand, providing a first page including a first area displaying a first item list corresponding to the search term and a second area displaying the list of related brands associated with the first brand, and providing, according to an input of a second brand included in the list of related brands, a second page including a third area displaying a second item list of the second brand. The program or computer readable instructions executed by the processor 110 may be previously stored in the memory 130 or received from the outside through the transceiver 120. The processor 110 may provide a first page to a display of the electronic apparatus 100.

The transceiver 120 may perform functions of transmitting information stored in the memory 130 of the electronic apparatus 100 or information processed by the processor 110 to another apparatus or receiving information from another apparatus to the electronic apparatus 100.

The memory 130 is a configuration implemented in a predetermined storage space of the electronic apparatus 100, which may include a database that functions such as storing, searching, deleting, editing, or adding data may be freely performed. For example, the memory 130 may have fields or elements for processing functions such as storing, searching, deleting, editing, or adding data. The memory 130 may store data related to performing information providing method by the electronic apparatus 100. For example, the memory 130 may store instructions or data for an execution operation of the processor 110. The memory 130 according to example embodiments may include a database for storing information on an item, and so on.

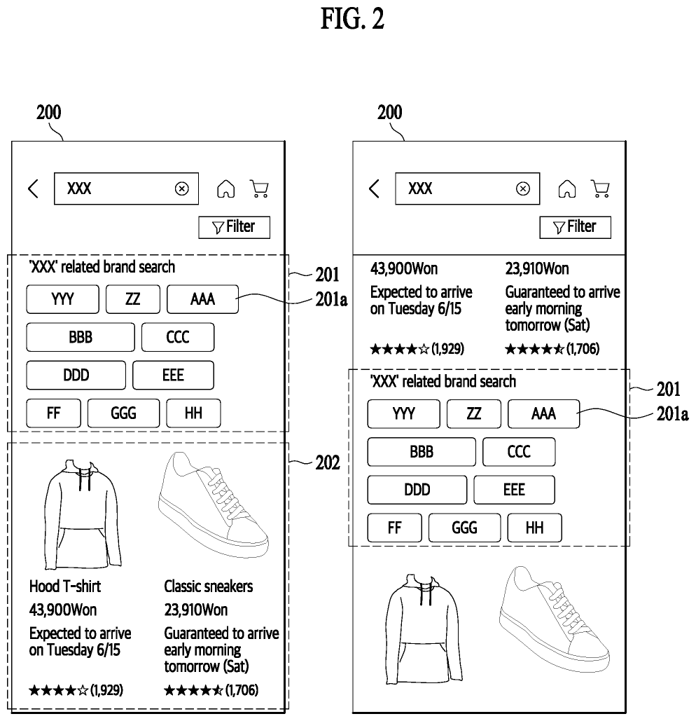

FIG. 2 illustrates an example of a search result page providing information on brand information and items according to example embodiments.

Some or all of the operations according to example embodiments shown in FIG. 2 may be performed by the electronic apparatus 100 according to example embodiments. FIG. 2 shows an example of a search results page 200. The search result page 200 may be a page that provides a result of searching for an item that a user of a service wants to purchase. The search result page 200 may include one or more user interfaces through which the user of the service can easily find a desired item from a list of items exposed in the search result. The search result page 200 may be referred to as a first page 200 hereinafter.

Referring to FIG. 2, the first page 200 may include at least one of an input interface for inputting a search term to search for a user item of the service, a first area 201 displaying a list of related brands associated with a brand included in the search term searched by the user of the service, and a second area 202 displaying a list of items of a search result searched by the user of the service.

The electronic apparatus according to example embodiments analyzes the search term received from the user of the service. The search term received from the user may include, for example, at least one of a name of an item and a category of an item (e.g., shoes, washing machine, etc.), and the search term may further include a brand of an item the user wants to purchase. In addition, the search term may include information input by the service user, and the electronic apparatus may identify related brand information based on the received search term. Throughout example embodiments, the electronic apparatus may identify a corresponding item based on the search term, and for convenience of explanation, it will be described as an item that the service user wants to purchase.

The electronic apparatus according to example embodiments identifies a first brand (e.g., ‘XXX’ in FIG. 2), which is a brand of the item that the user wants to purchase, from the search term. The electronic apparatus identifies a list(s) of related brand including the first brand. The electronic apparatus may display the brand(s) included in the identified list of related brands on the first area 201 according to example embodiments.

The list of related brands according to example embodiments is a list including the first brand, and may be a list including brands associated with the first brand. Meanwhile, the list of related brands including the first brand may be one or plural.

For example, when there are not one but a plurality of item categories associated with the first brand (i.e., when the first brand is an indication of origin for shoes, bags, and clothing), a plurality of lists of related brands may exist for each item. For example, the list of related brands may include other brand(s) associated with the first brand associated with the category of items the user searches for together. For example, the list of related brands for the first brand may include a first list of related brands including brands associated with the first brand with respect to the shoes category, and a second list of related brands including brands associated with the first brand with respect to the bag category, and so on.

Alternatively, the list of related brands for the first brand may consist of one list to include the related brand(s) including all item categories. For example, the list of related brands associated with the first brand may be a single list including brands associated with the first brand in relation to the shoes category, bag category, clothing category, and the like.

Meanwhile, the list of related brands including the first brand may be managed and stored separately for each classification of service users. For example, by separately updating the list of related brands for each age of service users, the electronic apparatus may store the separate list of related brands for each age. For example, the list of related brands including the first brand may include a first list of related brands updated to add or delete brand(s) in the list based on the search history or purchase history of service users in their 20s, a second list of related brands updated to add or delete brand(s) in the list based on the search history or purchase history and service users in their 30s, and so on. Also, for example, by separately updating the list of related brands according to the gender of service users, the electronic apparatus may store the separate lists of related brands by gender.

The list of related brands according to example embodiments may be periodically updated. The list of related brands according to example embodiments may be periodically updated by the electronic apparatus based on the search history, frequency of searches, search time, and search term of service users (or users of a specific group of service users).

The first area 201 according to example embodiments includes the list of related brands including brands related to the first brand corresponding to the search term searched by the user. The first area 201 according to example embodiments may include a detailed interface 201a for each brand in the list of related brands. The detailed interface 201a may be an interface for an electronic apparatus to search for a corresponding brand and display it on the second area 202 according to example embodiments. For example, when the user of the service clicks on the detailed interface 201a for the second brand displayed in the first area 201, the electronic apparatus may search for a plurality of items including the second brand as a search term and display the search result in the second area 202.

The second area 202 according to example embodiments displays one or more items appearing in a result searched by the user of the service. The second area 202 may include an image or video for each item, an item name, item review information, item price information, and item delivery-related information.

Meanwhile, there may be a case where a user requests a search using a search term, but the electronic apparatus fails to identify an item corresponding to the search term. That is, when there is no search result according to the user's search request, the electronic apparatus according to example embodiments may display items corresponding to the brand(s) in the list of related brands according to example embodiments to the second area 202 according to example embodiments. In this case, the electronic apparatus according to example embodiments may identify a brand with the highest sales volume or a brand with the highest search amount among brands in the list of related brands, and display items for the identified brand in the second area 202.

In addition, in an example embodiment, a brand corresponding to the search term may be identified based on an item included in the item list searched based on the search term obtained from the user. As an example, by inputting ‘shoes’ as a search term, a list of items corresponding thereto may be displayed, brands of items included in the item list may be identified, and the brand with the largest number may be identified as the brand corresponding to shoes. Meanwhile, in an example embodiment, based on the search term searched by the user based on user information, a brand that similar users have purchased the most may be identified as the brand corresponding to the corresponding search term.

The electronic apparatus according to example embodiments may help the user to search for a preferred brand without an additional user input procedure by managing and updating the list of brands related to the brand searched by the user and presenting them.

The electronic apparatus according to example embodiments may identify rapidly changing user needs, trends, and preferences by managing brands related to a brand searched by a user, and may provide a quick search function to the user's needs and trends.

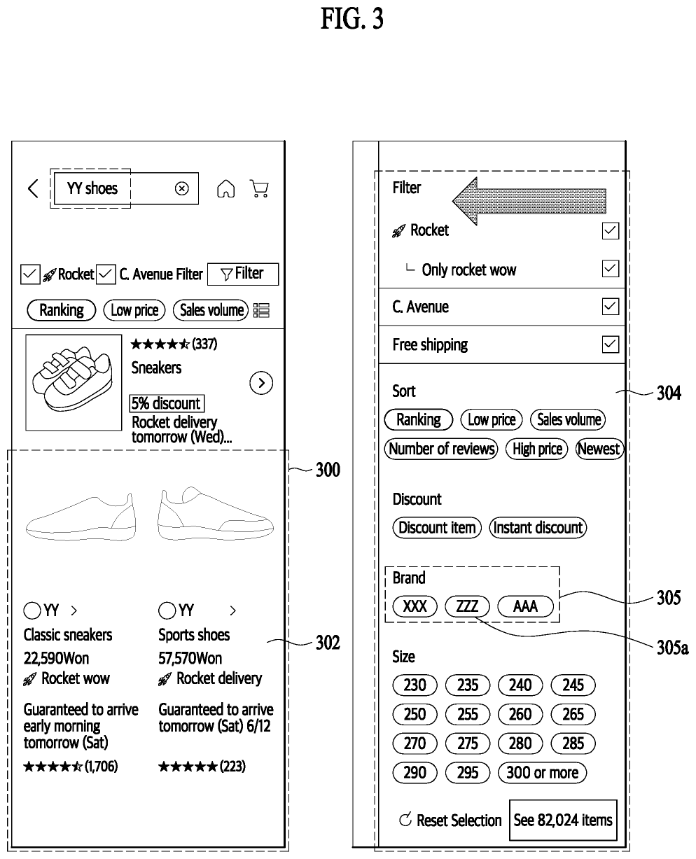

FIG. 3 illustrates an example of a search result page that provides brand information, information on an item, and a function for filtering items according to example embodiments.

Some or all of the operations shown in FIG. 3 may be performed by the electronic apparatus of FIGS. 1 and 2. FIG. 3 illustrates a search result page according to example embodiments. The search result page shown in FIG. 3 may be the first page of FIGS. 1 and 2.

Referring to FIG. 3, the first page may include a search interface 301 into which a user of a service enters a search term, and a second area 302 in which a search result is displayed according to the search term input by the user of the service.

Referring to FIG. 3, the first page may further include a filter interface 303 for the user of the service to select an item characteristic in order to filter some of the items included in the search result. For example, when the user of the service clicks on the filter interface 303, the electronic apparatus according to example embodiments may provide a terminal device of the user with a second page 304 for the user of the service to select characteristic(s) for filtering the item. The second page 304 may be displayed on the screen by, for example, sliding from one side or one direction of the screen in response to the user's click of the filter interface 303.

Referring to FIG. 3, the second page 304 may further include a third area 305 for filtering a plurality of items appearing in the search result by brand, and one or more areas for filtering the plurality of items appearing in the search result by the characteristics of the item (e.g., in the case of a shoes item, according to shoe size, etc.).

The third area 305 according to example embodiments may display all or some of brands of items appeared in the search result. The third area 305 may include a detailed interface(s) 305a for the user of the service to select the brand of each item appearing in the search result.

The third area 305 may include brand(s) included in the list of related brands for the first brand including the first brand, which is included in the search term searched by the user. That is, the electronic apparatus extracts the first brand from the user's search term. The electronic apparatus identifies the list of related brands associated with the first brand including the first brand. The list of related brands may be, for example, the list of related brands described with reference to FIG. 2, and the electronic apparatus may identify the list of related brands based on information about the user (e.g., the user's gender, the user's age, etc.). The electronic apparatus may select one or more from a plurality of related brand lists including the first brand based on the information about the user. The electronic apparatus may display, on the third area 305, brand(s) other than the first brand included in the selected or identified related brand list. The electronic apparatus may generate a detailed interface 305a for each other brand(s) included in the selected or identified related brand list and display it on the third area 305.

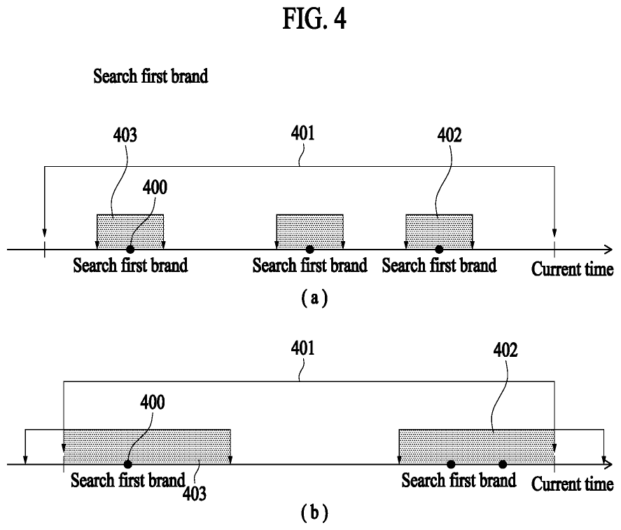

FIG. 4 illustrates an example of a method for generating and updating a related brand list according to example embodiments.

Some or all of the operations according to example embodiments shown in FIG. 4 may be performed by the electronic apparatus according to example embodiments. The electronic apparatus identifies the first brand from the search term received from the user of the service, and manages, stores, and updates one or more related brand lists including the first brand.

The electronic apparatus may update the stored related brand lists at a specific cycle (e.g., 1 day, 1 hour, etc.). The electronic apparatus may check a search history searched by users of the service in order to update the related brand lists.

Referring to FIG. 4A, first, the electronic apparatus according to example embodiments extracts sample users for generating a related brand list among users of the service. The sample users may be, for example, all users of the service, users of the service in their 20s among users of the service, or users of the service whose gender is male.

When sample users are selected, the electronic apparatus identifies other brands searched for at a time similar to the time when the first brand is searched for each user.

Specifically, the electronic apparatus sets a period (a first period) 401 from an update time (current time) to a specific period before. The first period 401 may be set differently for each category of items, and may be set differently according to user information (e.g., types of selected sample users (e.g., gender, age, etc.)). The first period 401 may be, for example, one month, one week, or one day.

The electronic apparatus may identify search time points 400 at which the first brand is searched for within the first period 401 for each user. The electronic apparatus identifies the brand(s) searched for by the user within a time before or after a specific period (i.e., within a second period 402) from the search time points 400 identified for each user. The second period 402 may mean a time interval within a time period before or after a specific period from each search time point 400. The second period 402 may exist differently for each user, and the electronic apparatus derives the second period 402 from the search time points 400 for each user. For example, the electronic apparatus may check the search time points 400 at which the first user searches for the first brand within the first period 401, and check other brand(s) searched by my first user during the second period 402 derived from the corresponding search time points 400.

The electronic apparatus may check the number of search frequencies of the brand(s) identified within the second period 402 for each user. The electronic apparatus may check the number of search frequencies of the brand(s) identified within the second period 402 for each user, and add at least one brand with a certain frequency number or a certain frequency rate, or higher than those to the related brand list.

The electronic apparatus checks the brand(s) in the previously stored related brand list, and, in the process of updating the related brand list, the related brand list newly derived by the number of search frequencies of the brand(s) identified within the second period 402 may be compared with them. The electronic apparatus may add brand(s) not included in the previously stored related brand list among the newly derived related brands to the previously stored related brand list.

Specifically, FIG. 4A shows a process of setting a period 403 for identifying other brand(s) to be included in the list of related brands for the first brand by the electronic apparatus using the first period 401 and the second period 402 for the first brand.

Referring to FIG. 4A, the electronic apparatus sets a first period 401 from the current time, checks the first brand search times 400 within the first period 401 for each user, and then derives a second period 402 from the search times 400 and the first period 401. Here, the second period 402 is included in the first period 401. When the second period 402 is derived, the electronic apparatus checks and counts 403 the brand(s) searched for by the user within the second period 402.

Meanwhile, referring to FIG. 4B, the second period 402 may be calculated within a time period from the time point 400 when the first brand is searched to the time point corresponding to before or after a specific time, but the second period 402 may be derived 403 within the range of the first period 401.

The electronic apparatus according to example embodiments may identify rapidly changing user needs, trends, and preferences by managing brands related to a brand searched by a user, and may provide a quick search function to the user's needs and trends.

The electronic apparatus according to example embodiments may accurately predict the needs and demand changes of users who want to purchase by setting the first period and the second period to determine the search amount of users for each brand, and efficiently manage and grasp the relation between brands.

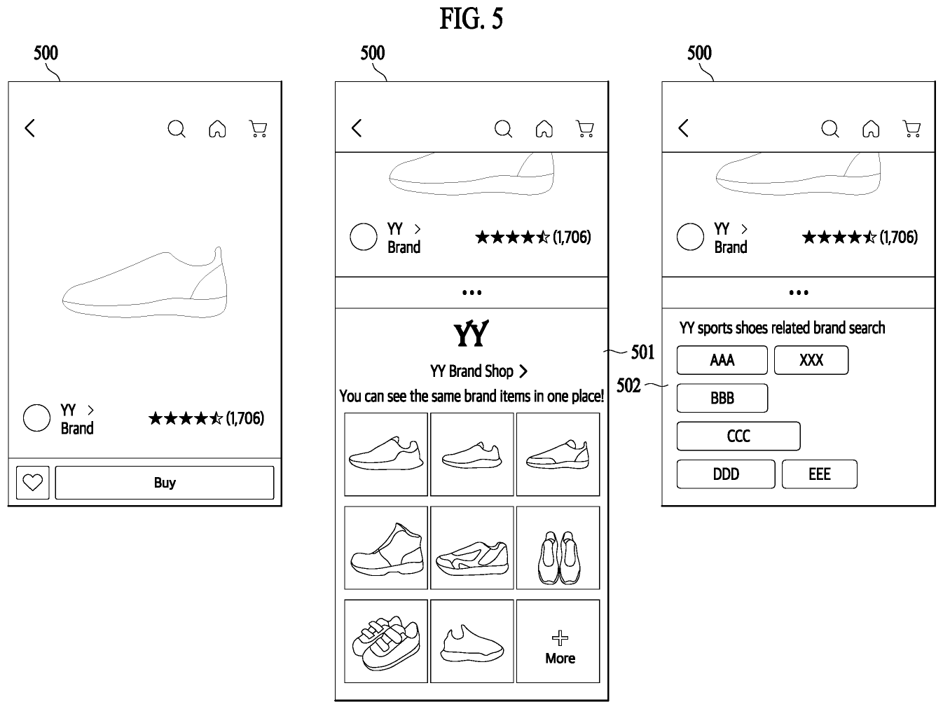

FIG. 5 shows an example of an item detail page according to example embodiments.

FIG. 5 illustrates an item detail page 500 according to example embodiments. The item detail page may be referred to as, for example, a third page 500. The third page 500 according to example embodiments may refer to a page that appears in response to a user clicking each item displayed in the second areas 202 and 302 in FIGS. 2 to 3.

The third page 500 may include, for example, detailed information about an item. The third page 500 may include, for example, at least one of an image or video of the item, review information of the item, and brand information of the item. The third page 500 may include a purchase interface for purchasing an item and a selection interface for storing the item in the shopping cart list.

The third page 500 may further include at least one of a fourth area 501 displaying detailed information on the brand of the corresponding item and a fifth area 502 displaying a list of related brands associated with the brand of the corresponding item.

The fourth area 501 displays information on other item(s) including the brand of the corresponding item. The fifth area 502 displays a list of related brands associated with the corresponding brand, including the brand of the corresponding item. The related brand list included in the fifth area 502 may mean, for example, a related brand list shown or created in FIGS. 2 to 4. The fifth area 502 may further include interface(s) configured for each brand(s) included in the related brand list. Each interface may be, for example, an interface for displaying a first page that displays a search result with the brand corresponding to the interface as a search term when a user clicks on the interface.

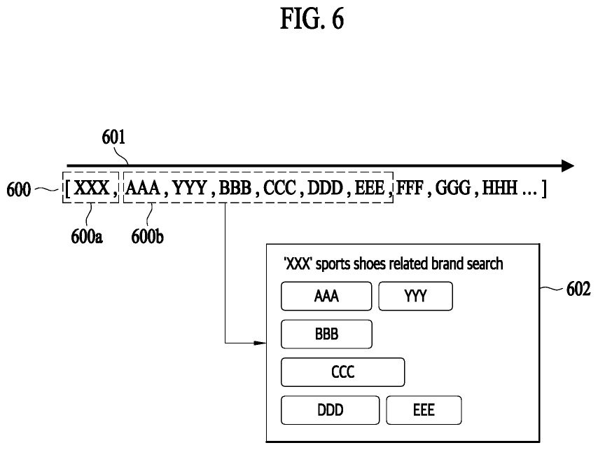

FIG. 6 illustrates an example of a method of generating, updating, and prioritizing a related brand list according to example embodiments.

Specifically, FIG. 6 illustrates an operation in which an electronic apparatus according to example embodiments generates and updates a related brand list. Also, FIG. 6 illustrates an example of a method of determining an order in which brands are displayed while the electronic apparatus according to example embodiments displays the related brand list on the first to third pages.

Referring to FIG. 6, 600 indicates a list 600 of related brands according to example embodiments, and it is assumed that the first brand 600a included in the search term searched by the user is ‘XXX’. Referring to the related brand list 600 associated with the first brand 600a, the related brand list may include a plurality of brands such as ‘YYY’ and ‘ZZZ’. The related brand list 600 may be updated and generated based on the operation(s) as shown in FIGS. 2 to 5.

The electronic apparatus according to example embodiments may sort brands other than the first brand 600a in order of priority in the identified related brand list 600. The electronic apparatus may select some or all of the brands 600b from among the other brands arranged in priority order. The electronic apparatus may display the selected some or all of the brands 600b on the areas 602 of the first to third pages rendered on the user's terminal device (e.g., the first area 201 of FIG. 2, the third area 305 of FIG. 5, the fifth area 502 of FIG. 5, etc.) sequentially or randomly.

The priority according to example embodiments may indicate a relationship with the first brand 600a. For example, the priority may be determined based on the search frequency numbers (or search frequency rates) of brands that have been searched for within a specific period (e.g., the second period of FIG. 4) derived from the time when each user searches for the first brand 600a. For example, since a brand searched for many times within the second period for each user according to example embodiments is highly correlated with the first brand, the corresponding brand may have a high priority.

The electronic apparatus according to example embodiments may promote purchases of other brands from users by determining the priorities and presenting items provided to users of services according to priorities.

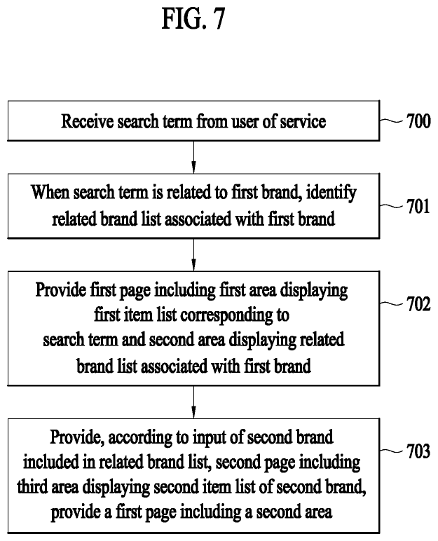

FIG. 7 is a flowchart illustrating a method of providing brand information according to example embodiments.

Some or all of the operations shown in FIG. 7 are included in the method for providing brand information, and some or all of the operations may be performed by the electronic apparatus according to example embodiments. The method for providing brand information according to example embodiments may include at least one of operations 700 to 702 of FIG. 7.

Referring to operation 700, the electronic apparatus according to example embodiments may receive a search term from a user of a service. The search term according to example embodiments may include at least one of a category of an item that the user wants to purchase, a name of the item, and a brand of the item.

Referring to operation 701, when the search term is associated with the first brand, the electronic apparatus according to example embodiments may identify a list of related brands associated with the first brand. The list of related brands according to example embodiments may be generated based on the search frequency of brands searched by other users who searched for the first brand. The list of related brands according to example embodiments may be updated every specific period.

The related brand list according to example embodiments may be generated based on operation(s) including at least one of checking times at which each user searched for the first brand within a first time period; setting at least one second time period for identifying brands searched by the user based on the times at which the first brand was searched for; and checking the search frequency of the brands searched by the user within the at least one second time period, and the related brand list may be generated or updated by the electronic apparatus according to example embodiments. In addition, the related brand list according to example embodiments may be generated differently for the age of the users who searched for the first brand and the gender of the users, and may be stored differently.

The first time period according to example embodiments may indicate a time period from a specific time before the current time to the current time, and at least one second time period may be included in the first time period.

Referring to operation 702, the electronic apparatus according to example embodiments may provide a first page including a first area displaying a first item list corresponding to a search term and a second area displaying the related brand list associated with the first brand.

When an item corresponding to the search term is not identified, the electronic apparatus according to example embodiments may include items related to brands other than the first brand, which are included in the related brand list, in the first area according to example embodiments

The electronic apparatus according to example embodiments may display the first brand and other brands included in the related brand list in an order determined according to priority. Here, the priority according to example embodiments may be determined based on the search frequency number for the other brands as described in FIG. 6.

The second area according to example embodiments may include a first interface for requesting to search for items for a second brand, which is different from the first brand and included in the related brand list, and the method for providing brand information may include displaying items for the second brand in the first area in response to the request. The second area according to example embodiments may or may not be displayed on the first page by the second interface included in the first page.

Referring to operation 703, the electronic apparatus according to example embodiments may provide a second page including a third area displaying a second item list of the second brand according to an input for the second brand included in the related brand list.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The electronic apparatus or terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer- readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

What is claimed is:

1. A method for providing brand information related to a search term in an electronic apparatus, the method comprising:
receiving the search term from a user of a service;
when the search term is associated with a first brand, identifying a list of related brands associated with the first brand;
providing a first page including a first area displaying a first item list corresponding to the search term and a second area displaying the list of related brands associated with the first brand; and
in response to an input for a second brand included in the list of related brands, providing a second page including a third area displaying a second item list of the second brand.

2. The method for providing brand information of claim 1, wherein the list of related brands is generated based on a search frequency of brands searched by other users who searched for the first brand.

3. The method for providing brand information of claim 2, wherein the list of related brands is updated every specific period.

4. The method for providing brand information of claim 2, wherein the list of related brands is generated based on:
checking times at which each user searched for the first brand within a first time period;
setting at least one second time period for identifying brands searched by the user based on the times at which the first brand was searched for; and
checking the search frequency of the brands searched by the user within the at least one second time period.

5. The method for providing brand information of claim 4, wherein the first time period indicates a time period from a specific time before the current time to the current time, and the at least one second time period is included in the first time period.

6. The method for providing brand information of claim 2, wherein the list of related brands is generated differently for each age and gender of the users who searched for the first brand.

7. The method for providing brand information of claim 2, wherein, when an item corresponding to the search term is not identified, the first area includes items related to brands other than the first brand, which are included in the list of related brand.

8. The method for providing brand information of claim 7, wherein:
the second area displays the brands other than the first brand included in the list of related brands in an order determined according to priority; and
the priority is determined based on each user's search frequency for the other brands.

9. The method for providing brand information of claim 8, wherein:
the second area includes a first interface for requesting to search for items for the second brand which is different from the first brand and included in the list of related brand; and
the method for providing brand information further comprises displaying items for the second brand in the first area in response to the request.

10. The method for providing brand information of claim 2, wherein the second area may or may not be displayed on the first page by a second interface included in the first page.

11. An electronic apparatus for providing item brand information, the apparatus comprising:
a memory configured to store at least one program; and
a processor configured to receive the search term from a user of a service, when the search term is associated with a first brand, identify a list of related brands associated with the first brand, provide a first page including a first area displaying a first item list corresponding to the search term and a second area displaying the list of related brands associated with the first brand, and provide, in response to an input for a second brand included in the list of related brands, providing a second page including a third area displaying a second item list of the second brand, by executing the at least one program.

12. A non-transitory computer-readable storage medium comprising:
a medium configured to store computer-readable instructions, wherein the computer-readable instructions causes, when executed by a processor, the processor to perform:
receiving the search term from a user of a service;
when the search term is associated with a first brand, identifying a list of related brands associated with the first brand;
providing a first page including a first area displaying a first item list corresponding to the search term and a second area displaying the list of related brands associated with the first brand; and
in response to an input for a second brand included in the list of related brands, providing a second page including a third area displaying a second item list of the second brand.
